(19) United States
(12) Patent Application Publication
(10) Pub. No.: US 2010/0000021 A1
(43) Pub. Date: Jan. 7, 2010

(54) Apparatus and Method for Laundering

(76) Inventors: David Ramati, Raanana (IL); Youval Saly, Kiryat Tivon (IL); Amir Sheelo, Kiryat Tivon (IL)

Correspondence Address: THE NATH LAW GROUP, 112 South West Street, Alexandria, VA, 22314, US

(21) Appl. No.: 11/794,162

(22) PCT Filed: Dec. 21, 2005
(86) PCT No.: PCT/IL05/01366

§ 371 Date: Jul. 12, 2007

(30) Foreign Application Priority Data
Dec. 27, 2004 (IL) 166012

(51) Int. Cl. C11D 3/42; D06F 33/00; D06F 33/02

(52) U.S. Cl. 8/137; 68/12.18

(57) ABSTRACT

A method for laundering textiles comprising washing the textiles using a cation solution; and bleaching and disinfecting the textiles using an anion solution.

### FIELD OF THE INVENTION

The present invention relates to laundry generally. More particularly it relates to An apparatus and method for cleaning and disinfecting laundry items, including clothing and other fabrics, using solutions of anions and cations.

### BACKGROUND OF THE INVENTION

The purpose of laundering is to clean laundry by removing dirt, soil, and contaminations from cloth and fabric, such as textiles. In conventional washing machines, cleaning is achieved by a combination of mechanical input from the machine, heated water, and chemical input from detergent and additives. The most important element in the process is the detergent, whose primary task is to remove the dirt and soil from the textiles. The detergent's effectiveness is dependent on the washing medium, which is usually water.

Consumer washing machines are used to launder home laundry, which usually comprises clothing, household linen, and the like. Industrial washing machines are used to launder commercial and industrial laundry, such as uniforms; hospital sheets, lab coats, patient bed clothes; restaurant tablecloths and napkins; hotel sheets and pillow cases; and other such items. Some of this laundry requires particular treatment, such as removing blood from hospital laundry or grease stains from work clothes.

The user of the washing machine determines the appropriate program for the different types of textile to be treated in the washing machine. Each program uses different amounts of additives, such as enzymes to remove blood and solvent to remove oil stains. Each program comprises various stages, and each stage has a predefined water level, working temperature, duration, and required additives.

Typically the laundering process, particularly industrial laundering, comprises the following stages: soaking, washing, disinfecting and bleaching, and rinsing. While that is the typical process, it can vary depending on the requirements of the type of laundry being laundered. In that case one or more of these stages may be omitted, one or more can be run one or more times, and/or the order can be changed.

Water functions as a transport medium for the detergents and must remove the released dirt and soil. During the washing process the water is often heated, sometimes as high as 90 degrees Centigrade (C). Heating, although enhancing the cleaning efficiency, during washing, brings about the accumulation of calcified sediments that eventually clog the washing machine, and especially its heating pipes.

In order to avoid sedimentation of minerals such as Calcium and Magnesium in the washing machine or on the textiles, it is necessary to use softened water in the process.

Removal of dirt and soil from textiles can be accomplished with chemical reaction. In some cases the dirt and soil consist of substances that cannot simply be removed by chemical treatment. In that case only displacement by an interfacial process will clean the substrate. For this reason, some detergents are enhanced with surfactants and auxiliary agents.

Other conventional ways to improve laundering involve adjustments of the length of the stage, the water temperature, or the movement of the washing machine.

Another way to improve the laundering is to exploit the electrical properties of water.

One attempt to do this is by Sanyo Electric Co. Ltd. of Japan, which announced, in a press release dated 22 Jun. 2001, a washing machine that applied electrolytic water to augment the effect of detergent. The Sanyo washing machine “uses electrolyzed water power produced using electrodes placed on the side of the wash basin that produce active oxygen and hypochlorous acid that work to dissolve organic dirt . . . . ”

Sanyo uses electrolysis and not electrochemicals. It does not provide a cleaning solution (with a pH greater than 10) to open the fabric in order to release the contaminated cloth. Also, Sanyo uses only bleaching elements.

Sanyo does not achieve the same cleaning results that can be achieved using anionic and cationic solutions.

Sanyo uses ultrasonic pulses to achieve mechanical work in order to clean the fabric. Ultrasonic pulses may damage the fabric and it is not accepted by the consumers.

Another attempt to apply electricity to washing laundry is provided by LG Electronics, Korea in United States Patent Application US20040206133 (A1), entitled “Washing machine”, which discloses a washing machine comprising “a plasma discharge unit for performing a plasma discharge on the washing water. According to this, a washing performance and a rinsing performance are enhanced and an amount of washing water is reduced.”

However LG Electronics does not achieve the same cleaning results that can be achieved using anionic and cationic solutions.

E. B. Altshul and V. V. Toropkov mention a washing technology used in laundry houses serving medical institutions in St. Petersburg in 1992.

They summarize their results in an article “Technology of Washing Household, Special and Hospital Laundry Using Solutions Synthesized by STEL Devices in St. Petersburg and Leningrad Region”, in the book “Electrochemical Activation In Industry” published for the First International Symposium on Electrochemical Activation In Industry in Moscow, Russian Republic in 1997.

A washing technology is not described but it is mentioned that it employs anolytes produced synthesized by a device referred to as a “STEL” system device. This is a general description that does not go into details. Moreover, Altshul and Toropkov conclude that a washing process involving detergents may be significantly enhanced using electro-chemically activated water. Particularly they do not suggest washing without detergents, without heating the water, or using hard water.

R. Sh. Perlovsky describes results of a laundering solution based on an electrochemically activated (ECA) solution comprising anolytes and catholytes. He summarizes his results in an article “Quality of waste water produced in the process of linen laundering using the new system with ECA solution application”, in the book “Electrochemical Activation In Industry” published for the Second International Symposium on Electrochemical Activation In Industry in Moscow, Russian Republic in 1999.

Perlovsky summarizes the results of research carried out in “about 50 experimental launderings” to investigate the effect of an electrochemically activated (ECA) solution on the quality of laundering and the processed wastewater. He mentions that the ECA solution comprises anolyte and catholytes.

He too reports that less detergent was required to achieve satisfactory washing results and that the waste water generated was correspondingly lower in ions and surfactants in the waste water.

He concludes:
“Application of ECA solutions in the process of washing allows to significantly (2 to 2.5 times) decrease the detergent consumption without deterioration of the solution washing capacity.”
“Application of the new washing system using ECA solutions indicates possible decrease of the toxicity of wastewater produced during laundering . . . . ”
“Adding anolyte to wastewater causes surfactant substance precipitation from the solutions, thus facilitating their further purification.”

Perlovsky does not address fundamental issues such as washing without any detergent; washing without heating the water (ambient temperature); optimizing the laundering by washing in only, or primarily, cationic solution; and bleaching and/or disinfecting in only, or primarily, anionic solution. His description appears to be of an experimental system in development rather than a mature system and method like that of the present invention for washing laundry using anionic and cationic solutions.

Harkins, et al., in U.S. Pat. No. 6,638,364 (2003) and entitled “SYSTEM TO CLEAN AND DISINFECT CARPETS, FABRICS, AND HARD SURFACES USING ELECTROLYZED ALKALINE WATER PRODUCED FROM A SOLUTION OF NaCl” disclose “A system and method for cleaning and disinfecting soft surfaces such as carpets, fabrics and the like . . . . The system and method uses electrolyzed alkaline water produced by an electrolysis process using a standard electrolyte solution of water and an electrolyte, wherein the electrolyte includes sodium chloride (NaCl) at a concentration between about 1% and 50%. In a preferred embodiment about a 20% concentration of sodium chloride is used. The electrolyzed alkaline water produced by this method is effective in cleaning and disinfecting both soft and hard surfaces.

Harkins uses only electrolyzed alkaline water, and their system and method are for cleaning surfaces, such as carpets, and not for laundering. Harkins teaches heating up the water and employing high-pressure to disperse the water on the carpets, the high-pressure also contributing to the physical removal of contaminants, and simultaneously using a mixture of cationic and anionic solutions.

The present invention provides a method and system for electrochemically-activated laundering that can be adapted for use in industrial and consumer washing machines. Cleaning of textiles is achieved by input of electrochemically-activated solutions and tap water (hard water).

Properties of a cationic solution are used for washing and properties of anionic solution are used for bleaching and disinfecting.

Objects and advantages of the present invention include:
Water consumption that is minimal (minimum height of water level in all stages).
Detergent consumption that is minimal or none (for most applications of the present invention no detergent is needed).
Life of the fabrics that is extended (less chemical damage).
Laundering process time that is minimal (less time then in traditional processes).
Water that is unheated—using water at ambient temperature (except minimum heating for laundering high contamination textiles, if required)
Water that may be hard-water.
Waste that is biodegradable.

### BRIEF DESCRIPTION OF THE INVENTION

There is thus provided in accordance with a preferred embodiment of the present invention, a method for laundering textiles, the method comprising:
washing the textiles using a cation solution; and
bleaching and disinfecting the textiles using an anion solution

Furthermore, in accordance with some preferred embodiments of the present invention, washing the textiles using cation solution is followed by draining the cation solution away.

Furthermore, in accordance with some preferred embodiments of the present invention, bleaching and disinfecting the textiles using anion solution is followed by draining the anion solution away.

Furthermore, in accordance with some preferred embodiments of the present invention, the method further comprises soaking the textiles prior to washing and bleaching and disinfecting.

Furthermore, in accordance with some preferred embodiments of the present invention, soaking the textiles is done more than once.

Furthermore, in accordance with some preferred embodiments of the present invention, soaking the textiles is done using water.

Furthermore, in accordance with some preferred embodiments of the present invention, the method further comprises rinsing the textiles after washing and bleaching and disinfecting.

Furthermore, in accordance with some preferred embodiments of the present invention, rinsing the textiles is done more than once.

Furthermore, in accordance with some preferred embodiments of the present invention, the method further comprises extracting liquids from the textiles after washing and bleaching and disinfecting.

Furthermore, in accordance with some preferred embodiments of the present invention, washing the textiles is done more than once.

Furthermore, in accordance with some preferred embodiments of the present invention, bleaching and disinfecting the textiles is done more than once.

Furthermore, in accordance with some preferred embodiments of the present invention, water is used.

Furthermore, in accordance with some preferred embodiments of the present invention, the water is at ambient temperature.

Furthermore, in accordance with some preferred embodiments of the present invention, wherein the water is heated.

Furthermore, in accordance with some preferred embodiments of the present invention, the quantity of water used is the minimum required to wet the textiles.

Furthermore, in accordance with some preferred embodiments of the present invention, the water comprises hard-water.

Furthermore, in accordance with some preferred embodiments of the present invention, the water comprises soft water.

Furthermore, in accordance with some preferred embodiments of the present invention, an auxiliary cleaning agent is used.

Furthermore, in accordance with some preferred embodiments of the present invention, anions and cations for the cation solution and the anion solution are produced using an electrochemical activation cell.

Furthermore, in accordance with some preferred embodiments of the present invention, the method further comprises diluting the cation solution and water.

Furthermore, in accordance with some preferred embodiments of the present invention, the method further comprises diluting the anion solution and water.

Furthermore, in accordance with some preferred embodiments of the present invention, anions and cations for the cation solution and the anion solution are produced from brine containing Potassium Chloride.

Furthermore, in accordance with some preferred embodiments of the present invention, anions and cations for the cation solution and the anion solution are produced from brine containing Sodium Chloride.

Furthermore, in accordance with some preferred embodiments of the present invention, the cation solution used in washing is characterized as having a pH value greater than 10.

Furthermore, in accordance with some preferred embodiments of the present invention, the anion solution used in bleaching and disinfecting is characterized as having an Oxidation Reduction Potential value greater than +800 millivolts.

Furthermore, in accordance with some preferred embodiments of the present invention, there is provided a washing apparatus for laundering textiles, comprising:
at least one container for receiving the textiles;
liquid feed for feeding liquid into the container;
anion solution feed for feeding an anion solution into the container;
cation solution feed for feeding a cation solution into the container;
driver for facilitating agitation of the textiles and liquids within container;
drain for draining liquids from the container;
control unit for controlling operation of the apparatus and performing laundering stages comprising:
   washing the textiles using a cation solution; and
   bleaching and disinfecting the textiles using an anion solution

Furthermore, in accordance with some preferred embodiments of the present invention, the container is a drum.

Furthermore, in accordance with some preferred embodiments of the present invention, the driver comprises a motor linked to the drum for rotating the drum.

Furthermore, in accordance with some preferred embodiments of the present invention, the anion solution feed and the cation solution feed are combined in a single feed.

Furthermore, in accordance with some preferred embodiments of the present invention, the apparatus further comprises an electrochemical activation cell for providing the anion solution and cation solution.

Furthermore, in accordance with some preferred embodiments of the present invention, the apparatus is provided with tanks, at least one tank for containing the anion solution and at least one tank for containing the cation solution.

Furthermore, in accordance with some preferred embodiments of the present invention, the apparatus is provided with a tank for containing brine.

### BRIEF DESCRIPTION OF THE FIGURES

The invention is described herein, by way of example only, with reference to the accompanying Figures, in which like components are designated by like reference numerals.

FIG. 1 is a block diagram of an industrial washing apparatus adapted for laundering using solutions of anions and cations in accordance with a preferred embodiment of the present invention.

FIG. 2 is a block diagram of a consumer washing apparatus adapted for laundering using solutions of anions and cations in accordance with a preferred embodiment of the present invention.

### DETAILED DESCRIPTION OF THE INVENTION

The present invention can be implemented on existing washing machines by adding the components of the invention to the washing machine. The invention is applicable for all types of washing machine, including industrial washing machines and consumer washing machines. The industrial machine can be any type of industrial washing machine(s), including continuous batch washer (tunnel washer).

Control of the invention can be implemented various ways: separate manual or automatic control, integrated into the washing machine control, etc.

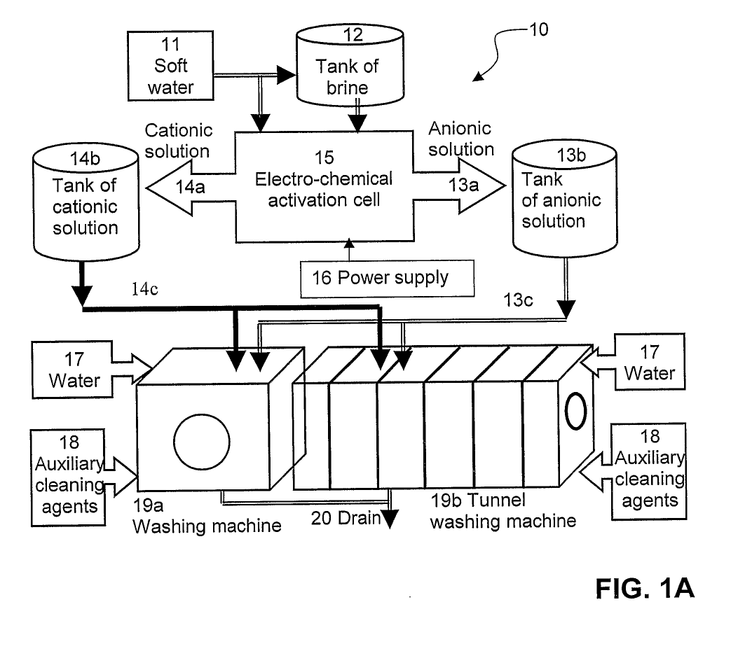

FIG. 1 is a block diagram of an industrial washing apparatus (hereinafter—washing machine) adapted for laundering using solutions of anions and cations in accordance with a preferred embodiment of the present invention. The apparatus is integrated with one or more industrial washing machines in accordance with a preferred embodiment of the present invention.

The washing machine is assumed to comprise standard washing machine components, including:
at least one drum for receiving the textiles;
a water feed for feeding water into the drum;
a motor and drive for rotating the drum;
a drain for draining liquids from the drum; and
a control unit for controlling operation of the machine and performing laundering stages.

The invention is shown in the Figure as external to the washing machines but could also be integrated, all or in part, inside the machines.

Water 11 is added to salts in brine tank 12 (optionally brine tank 12 can be omitted by adding a saturated salt solution or dry salt directly to water flowing to electro-chemical activation cell 15). Preferably the water 11 is softened water to avoid blocking up electrochemical activation cell 15. For example, the water can be softened by running it through a reverse osmosis unit. Brine preferably comprises Potassium Chloride (K⁺Cl⁻), Sodium Chloride (Na⁺Cl⁻), or a mixture of both salts. These salts are readily available and at low cost—however other salts may also be used.

Brine from tank 12 is diluted in water 11 in order to reach a desired working electrical current in the cell and added to electrochemical activation cell 15.

Electro-chemical activation cells 15 are familiar to those skilled in the art—their operation is summarized here for reference:
Low concentration brine passes into a cell (pipe or tube) comprising anode (+) and cathode (−) electroplates separated by a selective membrane. The membrane gives the electro-chemical activation cell the ability to separate the ions into two solutions.

When brine passes through the cell, cations flow to the cathode, and creates cation solution (Alkaline solution) with pH above 10.0, Anions flow to the anode and creates anion solution (Acidic solution) with pH under 3.5.

Electro-chemical activation cell 15 is connected to a power supply 16 that electrolyzes the positive and negative ions in the brine, for example, Potassium ions (K⁺) and Chloride ions (Cl⁻) to produce respectively a cationic solution 14a and an anionic solution 13a.

Cationic solution 14a is collected in storage tank 14b. Cationic solution 14a is an alkaline solution that provides excellent cleaning of lipid-based and organic stains during the laundering process and reduces or eliminates the need for detergents. Recommended values are: Potential of Hydrogen (pH) greater than 10 and ORP (Oxidation-Reduction Potential) less than −850 mV.

The above mentioned anion solution and cation solution are biodegradable and hence impose no environmental risk of contamination—a problem associated with washing with chemical detergents.

Anionic solution 13a is collected in storage tank 13b. Anionic solution 13a is an acidic Solution that is used primarily for disinfecting and bleaching during the laundering process. Recommended values are: pH less than 3.5, ORP greater than +800 mV, total Chlorine greater than 1500 ppm.

When required during the laundry cycle, cationic solution 14a flows from tank 14b into washing machine 19a and/or tunnel washing machine 19b via pipe 14c. When required during the laundry cycle, Anionic solution 13a flows from tank 13b into washing machine 19a and/or tunnel washing machine 19b via pipe 13c.

If required, auxiliary cleaning agents 18, such as enzymes or solvents can also be added during the laundry cycle, but for many types of laundry, cleaning agents are not necessary. For the purposes of the present invention adding detergents is not required, and in fact the present invention offers a detergent-free process, which is environmental-friendly.

Waste is drained through drain 20.

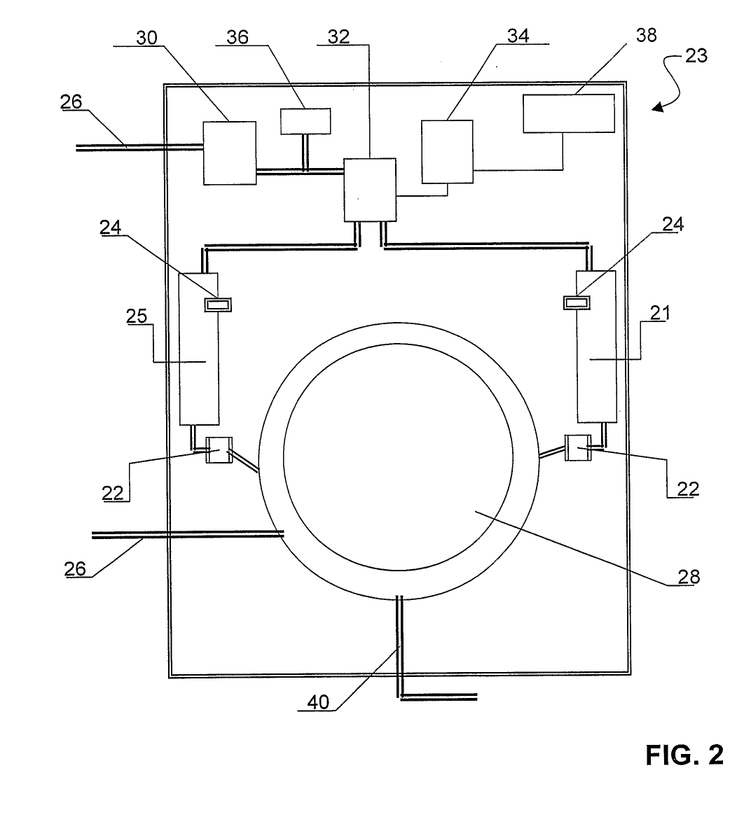

FIG. 2 is a block diagram of a consumer washing apparatus (hereinafter also—washing machine) adapted for laundering using solutions of anions and cations in accordance with a preferred embodiment of the present invention. The apparatus is integrated into consumer washing machine 23 in accordance with a preferred embodiment of the present invention.

The consumer-machine embodiment presented here is functionally similar to the industrial-machine embodiment presented in FIG. 1. In most cases the consumer-machine embodiment will be preferably integrated inside the casing of consumer machine 23 although it could be implemented all, or in part, externally to the consumer machine.

Water 26 (optionally passing through a softener, such as a reverse osmosis unit 30) mixes with saturated salt or dry salt from container 36 to form brine which enters electrochemical activation cell 32, which is connected to power supply 34, under the control of control unit 38.

Anionic solution flows from electrochemical activation cell 32 to anionic solution tank 25. Cationic solution flows from electrochemical activation cell 32 to cationic solution tank 21. Float switches 24 cut off supplies to the tanks when those tanks are nearly full. Electromechanical valves (normally closed) 22 are opened by control unit 38 at the appropriate times during the process stage to release the anionic solution or cationic solution into the washing drum 28 of the machine. Waste is drained through drain 40.

The drum mentioned hereinabove (with reference to both figures and any other embodiments of the present invention) is a convenient means for containing the textiles and agitating the textiles within the liquids involved in the process of laundering. However, other alternatives may also be used, such a container with an optional mechanical means for shaking the container, or for agitating its contents.

A method for laundering based on solutions of anions and cations and implemented using an industrial laundry machine provided with catholytes and anolyte solutions, such as shown in FIG. 1, is now described according to a preferred embodiment of the present invention. The method is substantially the same for the consumer laundry machine implementation shown in FIG. 2.

A preferred sequence of the method is provided below. In all the stages only a minimal quantity of liquid (preferably water) is normally required, minimal being only the quantity required to wet the laundry, and depends on the physical design of the washing machine.
Soaking stage: This is done using a minimal quantity of water 17. If desired, auxiliary cleaning agents 18 can be added, for example enzymes or solvents. This stage does not require heating of the water, unlike traditional processes (although heating may be useful for some types of heavily soiled laundry). Drain 20 drains soaking stage waste to sewage.
Washing stage: Cationic solution 14a is released into washing machine 19a and/or tunnel washing machine 19b drum from tank 14b via pipe 14c together with a minimal quantity of water 17. The preferred amount of cationic solution may range from 0.2 liter to 1 liter per 1 kg of laundry in a washing machine drum (the inventors have used 0.5 liter of cationic solution per 1 kg of laundry in a working industrial machine in full-scale operation). This stage is normally at least 15% shorter in process time compare to conventional laundering and does not normally require heating of the water (although heating may be useful for some types of heavily soiled laundry). Drain 20 drains washing stage waste to sewage.
Bleaching and disinfection stage: Anionic solution 13a is released into washing machine 19a and/or tunnel washing machine 19b drum from tank 13b via pipe 13c together with a minimal quantity of tap water 17. The preferred amount of anionic solution may range from 0.2 liter to 1 liter per 1 kg of laundry in machine drum (the inventors have used 0.5 liter of anionic solution per 1 kg of laundry in a working industrial machine in full-scale operation) This stage is normally at least 15% shorter in process time compare to conventional laundering and does not normally require heating of the water (although heating may be useful for some types of heavily soiled laundry). Drain 20 drains bleaching/disinfection stage waste to sewage.
Rinsing stage: Washing machine 19a and/or tunnel washing machine 19b drum is filled with minimal quantity of tap water. For washing machine 19a, the preferred cycle time is 2 minutes. Drain 20 drains rinsing stage waste to sewage. For tunnel washer 19b, only one compartment of the tunnel is used: the rinsing time is the transfer time of the tunnel, and the water is sent by counterflow to the bleaching compartments.
Extracting stage (applies for washing machines 19a): Machine 19 extracts the water from the linen. In a tunnel washer extraction is done by transferring the linen into a press or to an extractor connected to the tunnel. Drain 20 drains extracting stage waste to sewage.

Other laundering stages may be incorporated in the process to, but are not imperative to the present invention. The novel aspects of the method of the present invention specifically relate to the washing stage and the bleaching and disinfecting stage. Soaking is indeed recommended, but the laundering process can be conducted without it, and so are the rinsing and extracting stages.

The inventors of the present invention have tested their invention by operating a batch-type industrial washing machine using the method described hereinabove for a period of three months and have obtained remarkable cleaning results on hotel laundry, hospital laundry (which is heavily soiled and often contaminated with blood), restaurant maps (often heavily soiled with greasy stains and food residues). The consumers of the above mentioned textiles were very pleased with the results.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. A method for laundering textiles, the method comprising:
washing the textiles using a cation solution; and
bleaching and disinfecting the textiles using an anion solution

2. The method of claim 1, wherein the step of washing the textiles using cation solution is followed by draining the cation solution away.

3. The method of claim 1, wherein the step of bleaching and disinfecting the textiles using anion solution is followed by draining the anion solution away.

4. The method of claim 1, further comprising soaking the textiles prior to washing and bleaching and disinfecting.

5. The method of claim 4, wherein soaking the textiles is done more than once.

6. The method of claim 4, wherein soaking the textiles is done using water.

7. The method of claim 1, further comprising rinsing the textiles after washing and bleaching and disinfecting.

8. The method of claim 7, wherein rinsing the textiles is done more than once.

9. The method of claim 1, further comprising extracting liquids from the textiles after washing and bleaching and disinfecting.

10. The method of claim 1, wherein washing the textiles is done more than once.

11. The method of claim 1, wherein bleaching and disinfecting the textiles is done more than once.

12. The method of claim 1, wherein water is used.

13. The method of claim 12, wherein water at ambient temperature is used.

14. The method of claim 12, wherein the water is heated.

15. The method of claim 12, wherein the quantity of water used is the minimum required for wetting the textiles.

16. The method of claim 12, wherein the water comprises hard-water.

17. The method of claim 12, wherein the water comprises soft water.

18. The method of claim 1, wherein an auxiliary cleaning agent is used.

19. The method of claim 1, wherein anions and cations for the cation solution and the anion solution are produced using an electrochemical activation cell.

20. The method of claim 19, further comprising diluting the cation solution and water.

21. The method of claim 19, further comprising diluting the anion solution and water.

22. The method of claim 19, wherein anions and cations for the cation solution and the anion solution are produced from brine containing Potassium Chloride.

23. The method of claim 19, wherein anions and cations for the cation solution and the anion solution are produced from brine containing Sodium Chloride.

24. The method of claim 1, wherein the cation solution used in washing is characterized as having a pH value greater than 10.

25. The method of claim 1, wherein the anion solution used in bleaching and disinfecting is characterized as having an Oxidation Reduction Potential value greater than +800 millivolts.

26. A washing apparatus for laundering textiles, comprising:
at least one container for receiving the textiles;
liquid feed for feeding liquid into the container;
anion solution feed for feeding an anion solution into the container;
cation solution feed for feeding a cation solution into the container;
driver for facilitating agitation of the textiles and liquids within container;
drain for draining liquids from the container;
control unit for controlling operation of the apparatus and performing laundering stages comprising:
washing the textiles using a cation solution; and
bleaching and disinfecting the textiles using an anion solution

27. The apparatus of claim 26, wherein the container is a drum.

28. The apparatus of claim 27, wherein the driver comprises a motor linked to the drum for rotating the drum.

29. The apparatus of claim 26, wherein the anion solution feed and the cation solution feed are combined in a single feed.

30. The apparatus of claim 26, further comprising an electrochemical activation cell for providing the anion solution and cation solution.

31. The apparatus of claim 30, provided with tanks, at least one tank for containing the anion solution and at least one tank for containing the cation solution.

32. The apparatus of claim 31, provided with a tank for containing brine.
